(19) United States
(12) Patent Application Publication
(10) Pub. No.: US 2002/0120460 A1
(43) Pub. Date: Aug. 29, 2002

(54) Information providing system

(75) Inventor: Tatsuya Haraguchi, Yokohama-shi (JP)

Correspondence Address: Johnny A. Kumar, FOLEY & LARDNER, Washington Harbour, 3000 K Street, N.W., Suite 500, Washington, DC, 20007-5109, US

(73) Assignee: TOSHIBA TEC KABUSHIKI KAISHA

(21) Appl. No.: 09/794,630

(22) Filed: Feb. 28, 2001

(51) Int. Cl. G06F 17/60

(52) U.S. Cl. 705/1

(57) ABSTRACT

When an information terminal device has accepted search condition data through a display with a touch panel of an input/output section, the information terminal device transmits the search condition data to an information management apparatus via a network. The information management apparatus analyzes the received search condition data and sends search condition information based on an analysis result to each data server 1 via a network. Each data server 1 searches a commodity management database using the search condition information, and acquires associated search data and transmits the search data to the information management apparatus via the network. The information management apparatus receives the search information sent from each data server and batch-transmits the search information to the information terminal device via the network. The information terminal device displays the received search information on a display as a search result.

### BACKGROUND OF THE INVENTION

The present invention relates to an information providing system comprising one or plural data servers (e.g. data servers of individual travel planning agencies) in which paper-based information such as tour pamphlets is registered as electronic data), one or plural information terminal devices capable of searching for data and printing out desired information such as tour pamphlets, and an information network connecting the data servers and information terminal devices.

A great number of package tour pamphlets for providing information to customers have now been displayed in offices of travel agencies, package tour agencies, etc. In order to meet modern customer needs, the number of kinds of package tours tends to increase, while the amount of each kind of tours tends to decrease. In addition, the effective terms for providing package tours become short and various. Thus, the amount and the number of kinds of pamphlets to be managed in each office are very large, and each office bears a great work load for managing and changing displayed pamphlets.

In order to solve the problem, there is an idea that pamphlets are managed as electronic data so that customers may inspect and print out it on an as-needed basis.

For example, Jpn. Pat. Appln. KOKAI Publication No. 1-306204 discloses an example of a system for retrieving travel information and outputting travel pamphlets. In Jpn. Pat. Appln. KOKAI Publication No. 1-306204, necessary information may be selected and pamphlets with such information may be prepared and output. In this example, only necessary information for each customer is selected and a customer-specific pamphlet is prepared and output. In addition, it is considered to carry out a booking process in parallel with the pamphlet preparing/outputting process.

Similarly, Jpn. Pat. Appln. KOKAI Publication No. 10-207905 discloses an example in which goods information in a host computer is requested from a retrieval terminal device and is output. In this example, a device is made to decrease a time period between the issuance of the request from the retrieval terminal device and the output of the information.

Jpn. Pat. Appln. KOKAI Publication No. 5-341723 discloses a general example wherein data to be advertised is transmitted via a communication line and displayed on a display device. In Jpn. Pat. Appln. KOKAI Publication No. 5-341723, advertisement is output by the combination of an input terminal device, a communication processing apparatus and a display device. In this example, a device is made to make the advertisement content variable depending on a need. Moreover, it is considered to carry out a booking process in accordance with advertisement content by providing the display device with an input terminal device function.

Jpn. Pat. Appln. KOKAI Publication No. 7-93571 discloses an example of a system in which tour catalogues are prepared and output, although this system is not designed for acquisition of travel information by a customer. In Jpn. Pat. Appln. KOKAI Publication No. 7-93571, tour catalogues are prepared based on package tour information.

Where tour pamphlets are managed as electronic data to permit customers to inspect and print out the data on an as-needed basis, an information providing system can be composed of a data server for managing travel information and pamphlet data, a terminal device for enabling a customer to retrieve information and printing out pamphlets, and a communication line for connecting the data server and the terminal device. This information providing system realizes information retrieval, print-out request and pamphlet print-out.

In fact, however, package tour providing offices, in general, treat travel plans of plural travel plan agencies. If the information providing system using the above prior art is constructed in this situation, different systems need to be constructed for travel plan agencies having and managing pamphlet data, and information terminal devices need to be installed for the respective travel plan agencies.

In prior-art methods, use of an ordinary input interface for computers, such as a keyboard, a mouse or a touch panel, may be considered. However, such an input interface is difficult to use for customers who are not familiar with computer operations.

In addition, according to prior-art pamphlet providing methods employed in package tour providing offices, it is not possible to obtain detailed history data on the distribution of each pamphlet, such as “what type of customer?”, “when?” and “with what pamphlet?”. It is thus not possible to exactly understand pamphlet distribution tendencies in each office at respective time points and the trend of potential demands of customers who received pamphlets but were not directly associated with the sale of package tours.

Moreover, it is difficult to introduce complete automated processing to cope with inquiries and consultations on the contents of tour pamphlets and contracts required in procedures. Because of the nature of package tours, a face-to-face sale between the office staff and customer is sometimes needed in procedures other than advertisement and distribution of tour pamphlets. Under the circumstances, with the prior-art travel information providing system, it is difficult to realize the use of a single information terminal device or the establishment of a package tour providing office with no office staff (unmanned office).

### BRIEF SUMMARY OF THE INVENTION

An object of the present invention is to provide an information providing system for managing data transmission/reception via a network of an information terminal device in a centralized manner and using data servers of plural agencies in a synthesized manner, thereby realizing information providing services matching with the system of actual commodity handling businesses.

Another object of the invention is to provide an information providing system having means for reading information on paper, in addition to information input means such as buttons and an touch panel, thereby providing conventional input means to customers familiar with operations and providing input means using paper such as an operation sheet or an application sheet to customers not familiar with operations, thus enhancing the operational convenience for customers.

Still another object of the invention is to provide an information providing system capable of accumulating and analyzing history information on customer request processes, output processes and order processes, and enhancing the efficiency of planning and commodity handling.

Still another object of the invention is to provide an information providing system capable of outputting a map showing the route to the nearest window (office) from the location where an information terminal device is installed, thereby helping a customer go to the window with office staff, and realizing use of a single information terminal device and establishment of a commodity handling office with no office staff (unmanned office).

In order to achieve the above objects, the present invention provides an information providing system having one or more data servers in which various information is registered, an information management apparatus, connected to the data server via a communication line, for managing information, and an information terminal device, connected to the information management apparatus via a communication line, for retrieving and processing information, wherein the information terminal device comprises: input means for inputting an information search condition; first transmission means for transmitting search condition information input by the input means to the information management apparatus; and output means for outputting one or more information items which are provided from the information management apparatus in response to the search condition transmitted by the first transmission means, and the information management apparatus comprises: analysis means for analyzing the search condition provided from the information terminal device; acquisition means for retrieving and acquiring one or more information items registered in the associated one or more data servers on the basis of an analysis result of the analysis means; and second transmission means for batch-transmitting to the information terminal device said one or more information items acquired by the acquisition means from the one or more data servers.

The present invention also provides an information providing system having one or more data servers in which various information is registered, an information management apparatus, connected to the data server via a communication line, for managing information, and an information terminal device, connected to the information management apparatus via a communication line, for retrieving and processing information, wherein the information terminal device comprises: accumulation means for accumulating various information; and updating means for updating the various information accumulated in the accumulation means with one or more updating information items transmitted from the information management apparatus, and the information management apparatus comprises: determination means for determining whether the various information accumulated in the accumulation means should be updated or not; acquisition means for acquiring, when the determination means has determined that the various information should be updated, one or more updating information items registered in the associated one or more data servers; and transmission means for batch-transmitting to the updating means the one or more updating information items acquired by the acquisition means from the one or more data servers.

The present invention also provides an information providing system having one or more data servers in which various information is registered, an information management apparatus, connected to the data server via a communication line, for managing information, and an information terminal device, connected to the information management apparatus via a communication line, for retrieving and processing information, wherein the information terminal device comprises: display means for displaying various information; input means for inputting an order associated with the information displayed on the display means; first transmission means for transmitting order information input by the input means to the information management apparatus; and display means for displaying order result information provided from the information management apparatus in response to the order information transmitted by the first transmission means, and the information management apparatus comprises: analysis means for analyzing the order information provided from the information terminal device; process means for carrying out an order process to the associated data server on the basis of an analysis result of the analysis means; and second transmission means for transmitting order result information processed by the process means to the information terminal device.

The present invention also provides an information providing system having one or more data servers in which various information is registered, an information management apparatus, connected to the data server via a communication line, for managing information, and an information terminal device, connected to the information management apparatus via a communication line, for retrieving and processing information, wherein the information terminal device comprises: input means for inputting information process request data; first transmission means for transmitting the process request data input by the input means to the information management apparatus; and display means for displaying information which is provided from the information management apparatus in response to the process request data transmitted by the first transmission means, and the information management apparatus comprises: analysis means for analyzing the process request data provided from the information terminal device; acquisition means for retrieving and acquiring one or more information items registered in the associated one or more data servers on the basis of an analysis result of the analysis means; second transmission means for batch-transmitting to the information terminal device said one or more information items acquired by the acquisition means from the one or more data servers; and history management means for managing history information relating to the process request data provided from the information terminal device.

The present invention also provides an information providing system having one or more data servers in which various information is registered, an information management apparatus, connected to the data server via a communication line, for managing information, and an information terminal device, connected to the information management apparatus via a communication line, for retrieving and processing information, wherein the information terminal device comprises: display means for displaying, where necessary, guidance information including a map for guidance to a nearby office with staff, in a case where the information terminal device is installed in an unmanned office; instruction means for instructing printing of the guidance information displayed on the display means; and printing means for printing the guidance information according to the instruction by the instruction means.

### BRIEF DESCRIPTION OF SEVERAL VIEWS OF THE DRAWING

FIG. 1 is a block diagram showing the whole structure of an information providing system according to the present invention;

FIG. 2 is a block diagram showing a schematic structure of a data server;

FIG. 3 is a block diagram showing a schematic structure of an information management apparatus;

FIG. 4 is a block diagram showing a schematic structure of an information terminal device;

FIG. 5 shows an example of the structure of data stored in a print data DB on the data server and a terminal accumulation data DB on the information terminal device;

FIG. 6 shows an example of the structure of data stored in a commodity information DB on the data server;

FIG. 7 shows an example of the structure of data stored in a commodity management DB on the data server;

FIG. 8 shows an example of the structure of data stored in a data cache on the information management apparatus and in a data cache on the information terminal device;

FIG. 9 shows an example of the structure of data stored in an office information DB on the information management apparatus;

FIG. 10 shows an example of the structure of data stored in a terminal information DB on the information management apparatus;

FIG. 11 shows an example of the structure of data stored in a history DB on the information management apparatus;

FIG. 12 shows an example of a retrieval screen on a display of the information terminal device;

FIG. 13 is a flow chart for describing the operation of a retrieval process;

FIG. 14 shows an example of a retrieval result display screen displayed on the display of the information terminal device;

FIG. 15 is a flow chart illustrating the operation of print-out;

FIG. 16 is a flow chart illustrating the operation of an updating process for a terminal accumulation database DB of the information terminal device;

FIG. 17 shows an example of a retrieval condition designation sheet;

FIG. 18 shows an example of an application sheet;

FIG. 19 is a flow chart illustrating the operation an order process; and

FIG. 20 shows an example of an office designation screen.

### DETAILED DESCRIPTION OF THE INVENTION

An embodiment of the present invention will now be described with reference to the accompanying drawings.

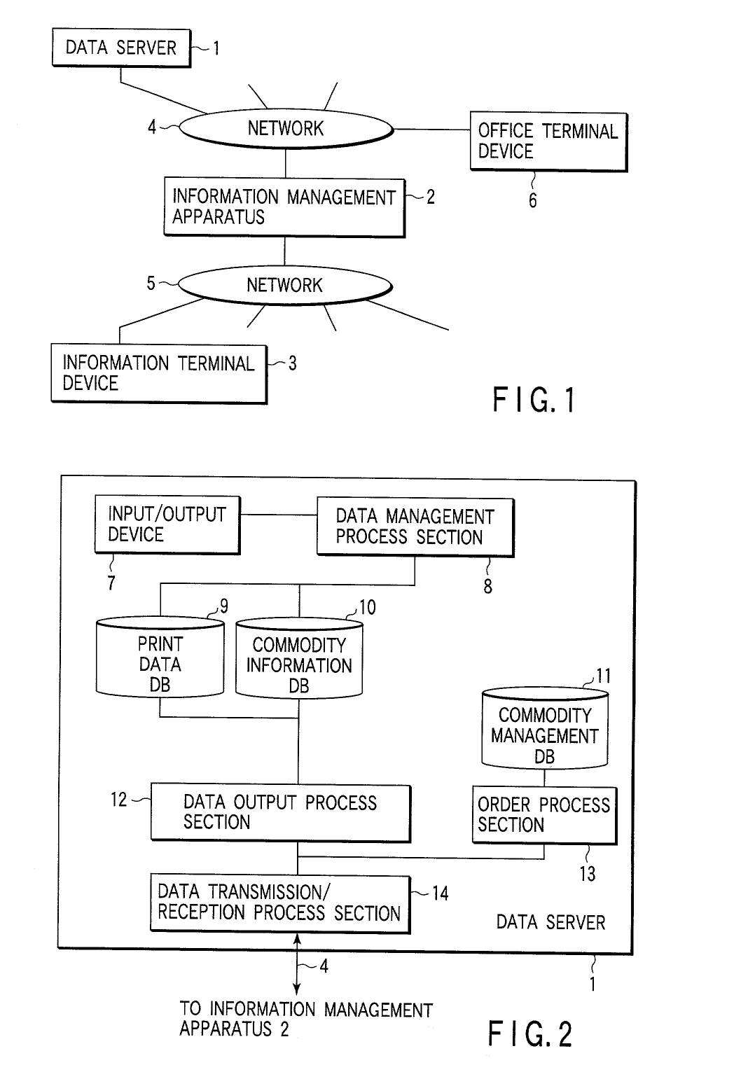

FIG. 1 shows the whole structure of an information providing system according to the present invention. The information providing system of this invention comprises one or more data servers 1, an information management apparatus 2, one or more information terminal devices 3, networks 4 and 5 for communication among them, and an office terminal device 6.

The data server 1 is connected to the information management apparatus 2 via the network 4. The information terminal device 3 is connected to the information management apparatus 2 via the network 5. The networks 4 and 5 may be a single network or independent networks.

In the prior art, the data server and the information terminal device are directly connected via a network. The present invention, however, is characterized in that the information management apparatus 2 is provided between the data server 1 and information terminal device 3.

In the structure of this invention, the data servers 1 are installed in the respective travel agencies that prepare and manage data, and the information terminal devices 3 are installed in the respective offices. The information terminal device 3 is mainly directed to the use by customers, while the office terminal device 6 is directed to the use by office staff for business processing.

FIG. 2 shows a schematic structure of the data server 1. The data server 1 comprises an input/output device 7 for data registration, a data management process section 8 for data management, a print data database (DB) 9 for storing electronic data of travel commodity pamphlets, a commodity information database (DB) 10 for storing detailed information of travel commodities, a database (DB) 11 for travel commodity management, a data output process section 12 for controlling data output, an order process section 13 for receiving input data and performing order processing, and a data transmission/reception process section 14 for data transmission/reception with the information management apparatus 2.

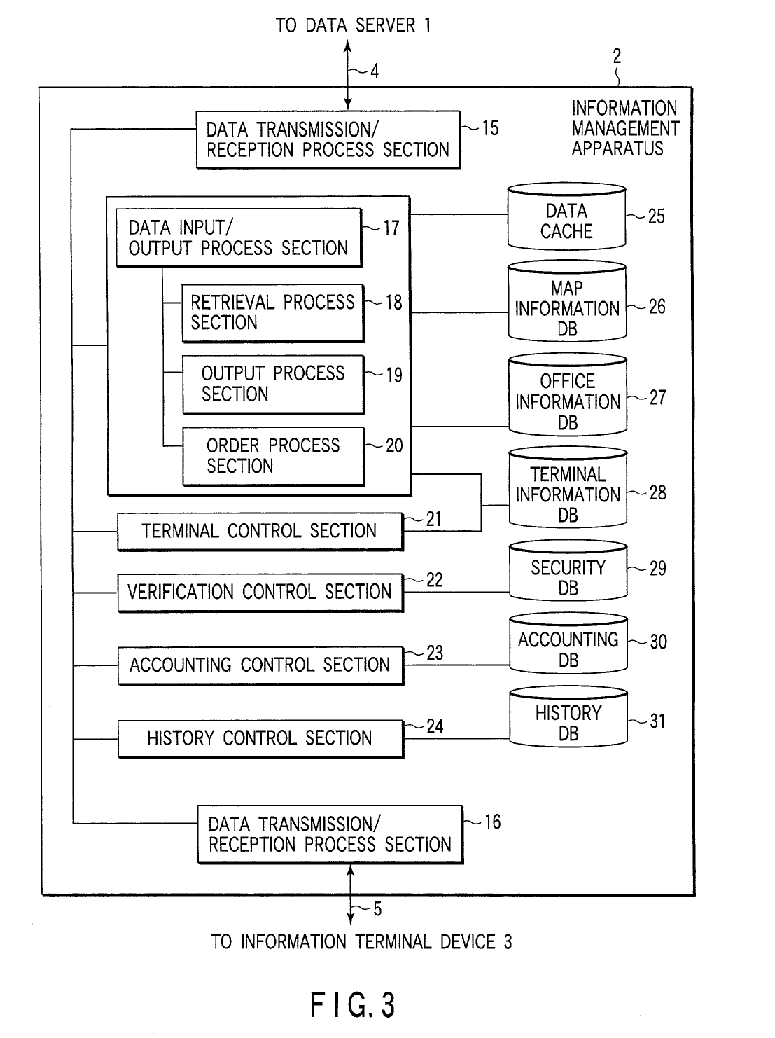

FIG. 3 shows a schematic structure of the information management apparatus 2. The information management apparatus 2 comprises data transmission/reception process section 15 for data transmission/reception with one or more data servers 1; a data transmission/reception process section 16 for data transmission/reception with one or more information terminal devices 3; a data input/output process section 17 for processing whole data input/output; a retrieval process section 18 connected to the data input/output process section 17; an output process section 19 connected to the data input/output process section 17; an order process section 20 connected to the data input/output process section 17; a terminal control section 21 for controlling the information terminal device 3, e.g. updating information stored in the information terminal device 3; a verification control section 22 for managing security in the input/output process; an accounting control section 23 for managing an accounting process associated with the input/output; a history control section 24 for acquiring and managing a data input/output history; a data cache 25 for temporarily storing data on the data server 1; a map information database (DB) 26 for storing data for outputting maps; an office information database (DB) 27 for storing office information; a terminal information data base (DB) 28 for storing information on the information terminal device 3; a security database (DB) 29 for storing security information for a verification process; an accounting database (DB) 30 for storing information for the accounting process; and a history database (DB) 31 for storing history data on data input/output.

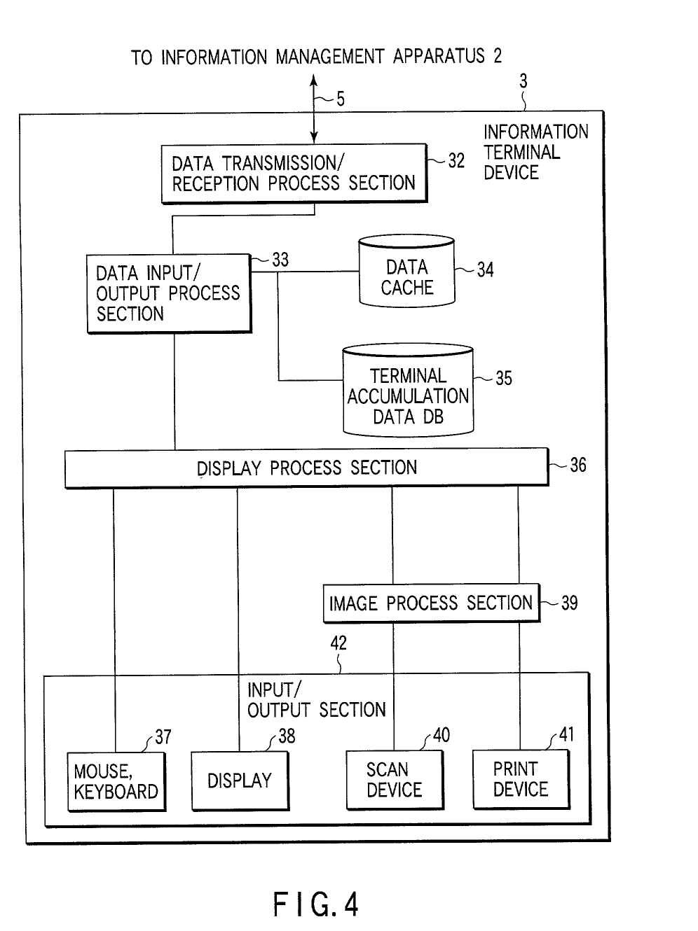

FIG. 4 shows a schematic structure of the information terminal device 3.

The information terminal device 3 comprises a data transmission/reception process section 32 for data transmission/reception with the information management apparatus 2; a data input/output process section 33 for processing data input/output; a data cache 34 for temporarily storing data; a terminal accumulation data database (DB) 35 for storing data in a case where data is to be stored on the information terminal device 3 side; a display process section 36 for carrying out a display process for an input/output section 42; an ordinary input/output device 37 comprising a mouse, keyboard, etc.; a display 38 having a touch panel; an image process section 39 for performing image processing when image is used in the input/output; and a scan device 40 and a print device 41 which are image input/output devices. The input/output section 42 is constituted by the mouse/keyboard 37, display 38, scan device 40 and print device 41.

The data structure in each database (DB) used in the present embodiment will now be described.

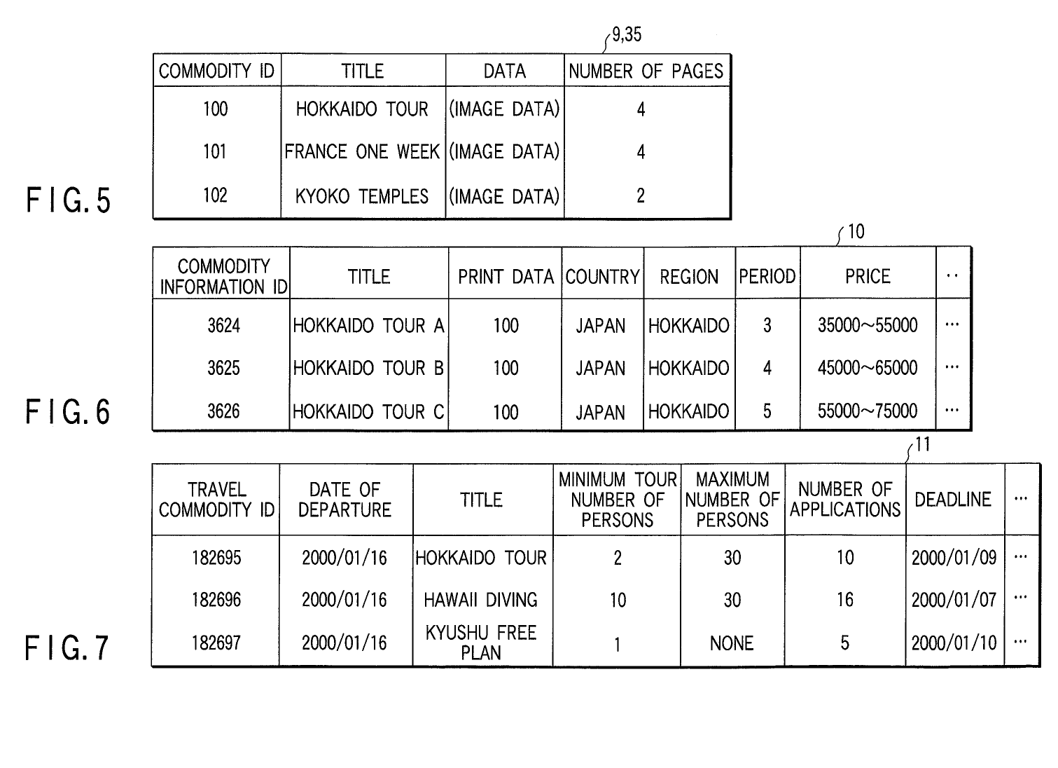

FIG. 5 shows an example of the structure of data stored in the print data DB 9 on the data server 1 and the terminal accumulation data DB 35 on the information terminal device 3. In this example, in connection with package tour commodity pamphlets, a commodity ID for identifying a package tour commodity, the title of the pamphlet, the number of pages, and image data of the pamphlet are stored. These information items may be batch-managed in the print data DB 9 on the data server 1, or individually managed in the terminal accumulation data DB 35 on each information terminal device 3, or these management modes may be combined. For example, as regards commodity ID 100, the title “HOKKAIDO TOUR”, data “(image data)”, and the number of pages “4” are stored.

FIG. 6 shows an example of the structure of data stored in the commodity information DB 10 on the data server 1. In this example, various travel commodity information for use in retrieval of tour pamphlets is stored. Specifically, the commodity information DB 10 stores commodity information ID for identifying a tour commodity, the title, print data, country, region, period, price, etc. The information stored in the print data DB 9 and commodity information DB 10 on the data server 1 is managed, e.g. registered, updated or deleted, from the input/output device 7 via the data management process section 8. For example, as regards commodity information ID 3624, the title “HOKKAIDO TOUR A”, print data “100”, country “JAPAN”, region “HOKKAIDO”, period “3”, price “35000-55000”, etc. are stored.

FIG. 7 shows an example of the structure of data stored in the commodity management DB 11 on the data server 1. In this example, information on booking/registration of package tour commodities is stored. Specifically, the commodity management DB 11 stores tour commodity ID for identifying a tour commodity, date of departure, title, minimum tour number of persons, maximum number of persons, number of applications, deadline, etc. For example, as regards tour commodity ID 182695, the date of departure “2000/01/16”, the title “HOKKAIDO TOUR”, the minimum tour number of persons “2”, the maximum number of persons “30”, the number of applications “10” the deadline “2000/01/09”, etc. are stored.

The order process section 13 on the data server 1 refers to the commodity management DB 11 for application of tour commodities and inquiries on booking in the information providing system of the present invention. The commodity management DB 11 is also accessed from another system such as an already existing commodity management system or the office terminal device 6.

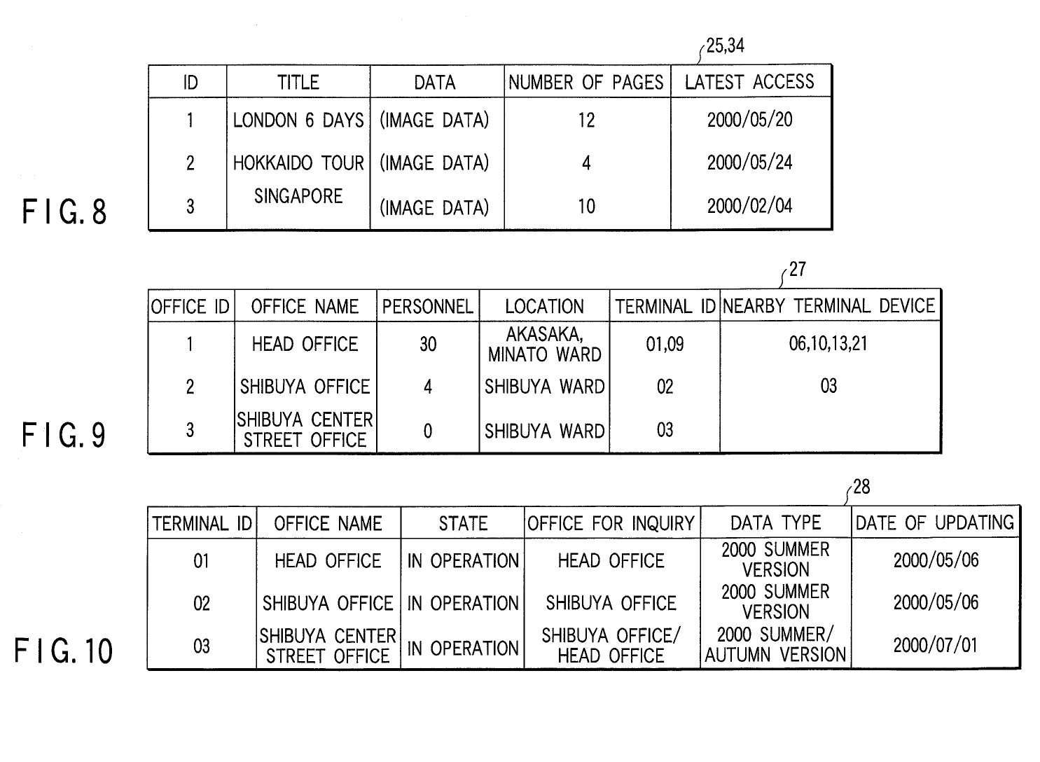

FIG. 8 shows an example of the structure of data stored in the data cache 25 on the information management apparatus 2 and the data cache 34 on the information terminal device 3. In this example, an ID serving as an identification number, the title of a tour pamphlet, the number of pages, pamphlet image data and a latest access date/time usable as a criterion for data storage/deletion are stored. For example, as regards the ID 1, the title “LONDON 6 DAYS”, data “(IMAGE DATA)”, the number of pages “12” and the latest access “2000/05/20”, are stored.

The data management of the data cache 25 on the information management apparatus 2 is effected by the data input/output process section 17, and the data management of the data cache 34 on the information terminal device 3 is effected by the data input/output process section 33.

FIG. 9 shows an example of the structure of data stored in the office information DB 27 on the information management apparatus 2. In this example, information on offices equipped with the information terminal devices 3 of the information providing system of the present invention is stored. Specifically, the office information DB 27 stores general information such as the office ID, office name, personnel and location, as well as the terminal ID of the information terminal device 3 in the office and the ID of the information terminal device 3 installed nearby.

It is understood that the “SHIBUYA CENTER STREET OFFICE” of office ID “3” has personnel “0” and this office is an unmanned office with only the information terminal device 3 installed. In addition, since the nearby terminal devices of the “SHIBUYA OFFICE” of office ID “2” includes terminal ID “03”, the “SHIBUYA CENTER STREET OFFICE” of office ID “3” having the terminal ID “03” and the “SHIBUYA OFFICE” of office ID “2” are located close to each other. It is understood that if there is a need to guide a customer from the “SHIBUYA CENTER STREET OFFICE”, which is the unmanned office, to a nearby window with office staff, it is possible that the customer is guided to the “SHIBUYA OFFICE”.

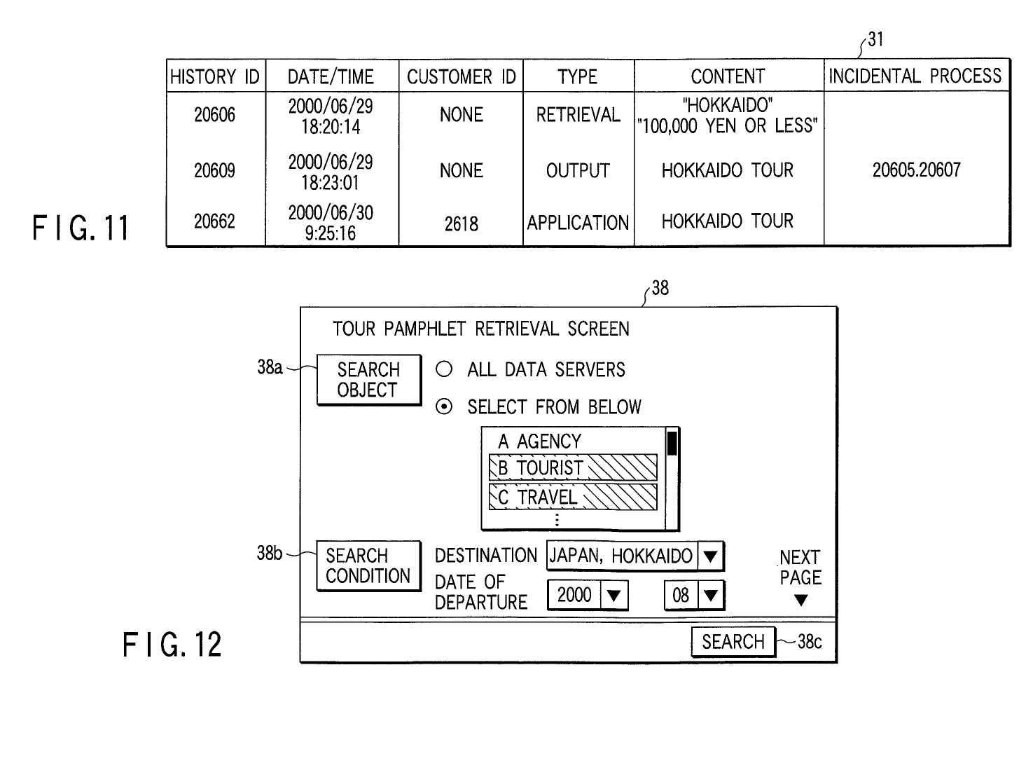

FIG. 10 shows an example of the structure of data stored in the terminal information DB 28 on the information management apparatus 2. In this example, detailed information on each information terminal device 3 managed by the information management apparatus 2 is stored. The terminal information DB 28 stores a terminal ID for identifying each information terminal device 3, an office name in which each information terminal device 3 is installed, an operation state of the information terminal device 3, the name of the office (office for inquiry) managing each information terminal device 3, the kind of content (data type) in the terminal accumulation data DB 35, and the date of updating. For example, as regards the terminal ID “01”, the office name “HEAD OFFICE”, the state “IN OPERATION”, the office for inquiry “HEAD OFFICE”, the data type “2000 SUMMER VERSION”, and the date of updating “2000/05/06” are stored.

FIG. 11 shows an example of the structure of data stored in the history DB 31 on the information management apparatus 2. In this example, history information on each input/output data item handled by the information management apparatus 2 is stored. The history DB 31 stores a history ID for identifying each history data item, a date/time, a customer ID of a customer who executed input/output, a history data type, a commodity content, and an incidental process due to input/output data. For example, history ID “20609” indicates that the date/time is “2000/06/29 18:23:01”, the customer ID is “NONE”, and the type is “OUTPUT”. It is thus indicated that the pamphlet was output and the content of the pamphlet is “HOKKAIDO TOUR”. In addition, it is indicated that history IDs “20605” and “20607” were executed as incidental processes. In this way, by referring to the data “INCIDENTAL PROCESS”, combinations of processes can be understood when plural pamphlets were output. For example, it is understood what combinations of pamphlets were output.

Although the data structures of the map information DB 26, security DB 29 and accounting DB 30 on the information management apparatus 2 are not exemplified, they are assumed to be equivalent to those of conventional database systems.

A specific operation of the system with the above structure will now be described.

In the information providing system of the present invention, tour pamphlets can be retrieved by a customer's operation through the information terminal device 3.

FIG. 12 shows an example of a retrieval screen on the display 38 with a touch panel in the information terminal device 3. A search object input section 38a for selecting and designating the data server 1 to be searched is provided in addition to a conventional search condition input section 38b. After necessary items (search condition data) have been input through the display 38 with the touch panel, the customer presses a search button 38c on the display 38 with the touch panel. Thus, the retrieval process is started.

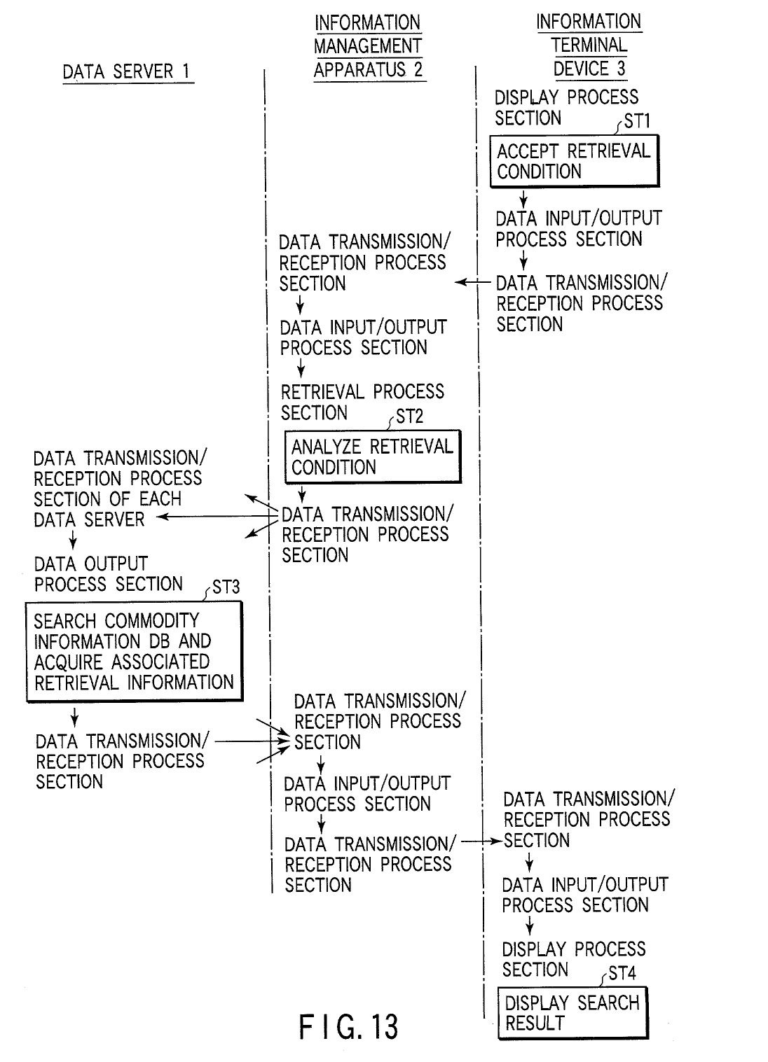

The retrieval process operation will now be described with reference to a flow chart of FIG. 13.

If the search conditions are accepted through the touch-panel-equipped display 38 of the input/output section 42 of the information terminal device 3 (ST1), the data input/output process section 33 transmits the search condition data from the data transmission/ reception process section 32 to the information management apparatus 2 via the network 5.

In the information management apparatus 2, the data input/output process section 17 sends the search condition data, which has been received from the data transmission/reception process section 16, to the retrieval process section 18. The retrieval process section 18 analyzes the received search condition data (ST2). The data input/output process section 17 transmits the search condition information based on the analysis result to each data server 1 from the data transmission/reception process section 15 via the network 4.

In each data server 1, the data output process section 12 searches the commodity management DB 10 via the order process section 3, using the search condition information received at the data transmission/reception process section 14. Thus, the associated search information is acquired (ST3). The data output process section 12 transmits the acquired search information (search result) to the information management apparatus 2 from the data transmission/reception process section 14 via the network 4.

In the information management apparatus 2, the data input/output process section 17 receives via the data transmission/reception process section 15 the search information sent from each data server 1. The received search information is batch-transmitted to the information terminal device 3 from the data transmission/reception process section 16 via the network 5.

In the information terminal device 3, the data input/output process section 33 sends to the display process section 36 the search information received at the data transmission/reception process section 32. The display process section 36 processes the received search information and displays it on the display 38 as the search result (ST4).

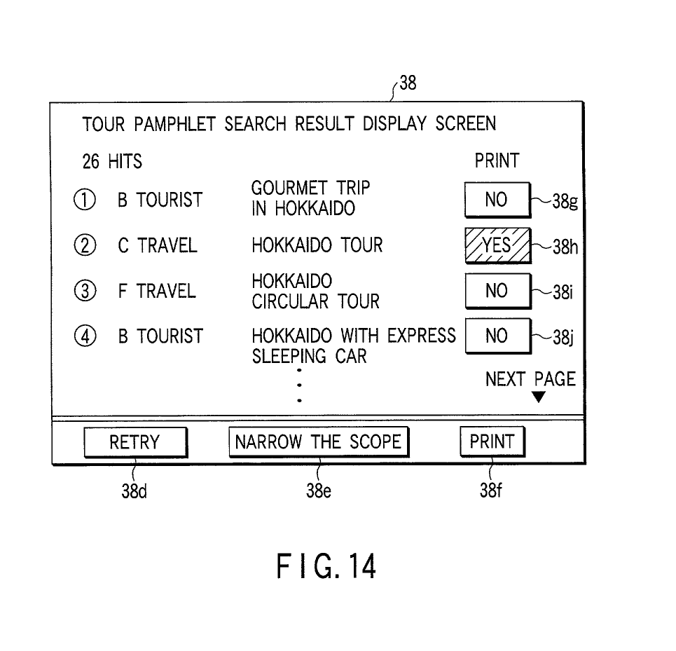

FIG. 14 shows an example of the search result display screen which is displayed on the touch-panel-equipped display 38 of the information terminal device 3 in step ST4. The information (B Tourist, C Travel, F Travel, B Tourist, etc.) from the plural data servers 1 is collected and displayed on the single screen. In this case, the information of the actually desired pamphlet is selected on the screen (select buttons 38g-38j). If a print button 38 is pressed, the tour pamphlet is printed out.

In this embodiment, both the search condition analysis process and the search information acquisition process for the commodity information DB 10 are performed in the information management apparatus 2. However, the search condition analysis process may be performed in the information terminal device 3, and only the process associated with the plural data servers 1 may be performed in the information management apparatus 2.

In the retrieval process operation as described above, the processing in the information management device 2 intervenes between the processing in the information terminal device 3 and the processing in the data server 1. Thereby, the information in the plural data servers 1 can be accessed from the single information terminal device 3 without the presence of plural data servers 1 being taken into account.

The commodity information DB 10 is referred to in the process of step ST3 in the data server 1. The search condition information is compared with the content of the commodity information DB 10, and the search information (search result) meeting the search conditions is sent to the information management apparatus 2. For example, if there is the commodity information DB 10 as shown in FIG. 6 and the search conditions are “HOKKAIDO” and “50000 Yen”, these conditions are met by the information on tour commodity IDs “3624” and “3625”. Accordingly, this tour commodity information is sent to the information management apparatus 2 as search information (search result). In the information management apparatus 2, all search results including search results obtained from other data servers 1 are batch-transmitted to the information terminal device 3.

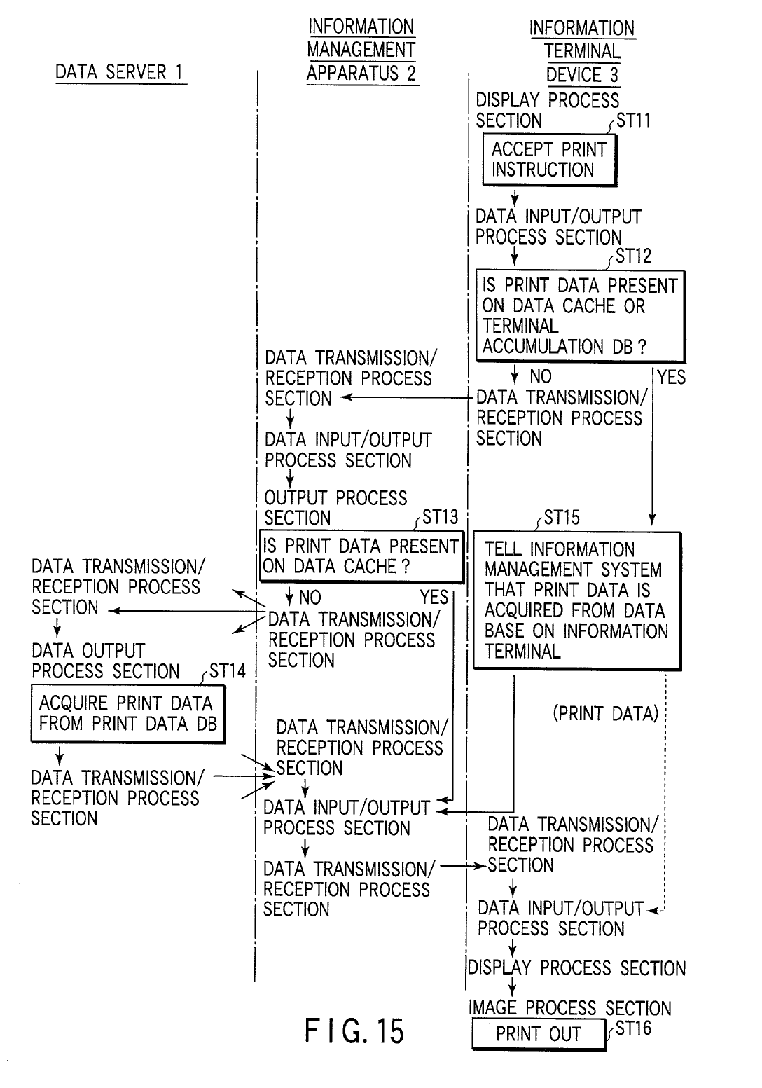

The print-out operation will now be described with reference to a flow chart of FIG. 15.

In the information terminal device 3, when the select buttons 38g to 38j and print button 38f on the touch-panel-equipped display 38 have been pressed, the display process section 36 accepts the print instruction (ST11). When the display process section 36 has accepted the print instruction, the data input/output process section 33 confirms whether print data is present in the data cache 34 or terminal accumulation DB 35 (ST12).

If the print data is not present in step ST12, the data input/output process section 33 transmits the print instruction information from the data transmission/reception process section 32 to the information management apparatus 2 via the network 5.

In the information management apparatus 2, as regards the data input/output process section 17, the output process section 19 confirms whether the print data is present in the data cache 25, based on the print instruction information received at the data transmission/reception process section 16 (ST13). If the print data is not present in step ST13, the data input/output process section 17 sends the print instruction information from the data transmission/reception process section 15 to each data server 1 via the network 4.

The data output process section 12 in the data server 1 searches the print data DB 9 using the print instruction information received at the data transmission/reception process section 14, thereby acquiring the associated print data (ST14). Subsequently, the data output process section 12 sends the acquired print data from the data transmission/reception process section 14 to the information management apparatus 2 via the network 4.

In the information management apparatus 2, the data input/output process section 17 transmits the print data, which has been received at the data transmission/reception process section 15, to the information terminal device 3 from the data transmission/reception process section 16 via the network 5. If the print data is present in step ST13, the data input/output process section 17 transmits the print data from the data transmission/reception process section 16 to the information terminal device 3 via the network 5.

In the information terminal device 3, the data input/output process section 33 sends the print data, which has been received at the data transmission/ reception process section 32, to the display process section 36 so that the print data may be printed out from the print device 41 via the image process section 39 (ST16).

If the print data is present in step ST12, the data input/output process section 33 in the information terminal device 3 informs the information management apparatus 2 via the data transmission/reception process section 32 and network 5 that the print data is to be acquired from the database (data cache 34 or terminal accumulation DB35) of the information terminal device 3 (ST15). In the information management apparatus 2, the history control section 24 stores the content of the reported print data in the history DB 31 as history management data. The data input/output process section 33 sends the print data acquired from the database (data cache 34 or terminal accumulation DB 35) of the information terminal device 3 to the display process section 36 so that the print data may be printed out from the print device 41 via the image process section 39 (ST16).

In the above-described example of operation, the information terminal device 3 has the data cache 34 and terminal accumulation data DB 35, and the information management apparatus 2 has the data cache 25. In the processing with this structure, it is determined whether the desired print data is present or not.

For example, in a case where “HOKKAIDO TOUR” is designated as a desired pamphlet, if the data cache 34 of the information terminal device 3 has the content as shown in FIG. 8, the data with ID “2” is the desired data and the desired pamphlet can be printed out without receiving the print data from the information management apparatus 2. However, even where the print data on the information terminal device 3 is used, the execution of the print process is reported to the information management apparatus 2. This is because history management needs to be done in the information management apparatus 2.

If the desired print data is not present in the database (data cache 25, 34, and terminal accumulation DB 35) on the information terminal device 3 and information management apparatus 2, the content of the print data DB 9 on the data server 1 is referred to. For example, the print data DB 9 has the content as shown in FIG. 5, the data with commodity ID “100” is the desired print data and is sent to the information terminal device 3 via information management apparatus 2 for printing.

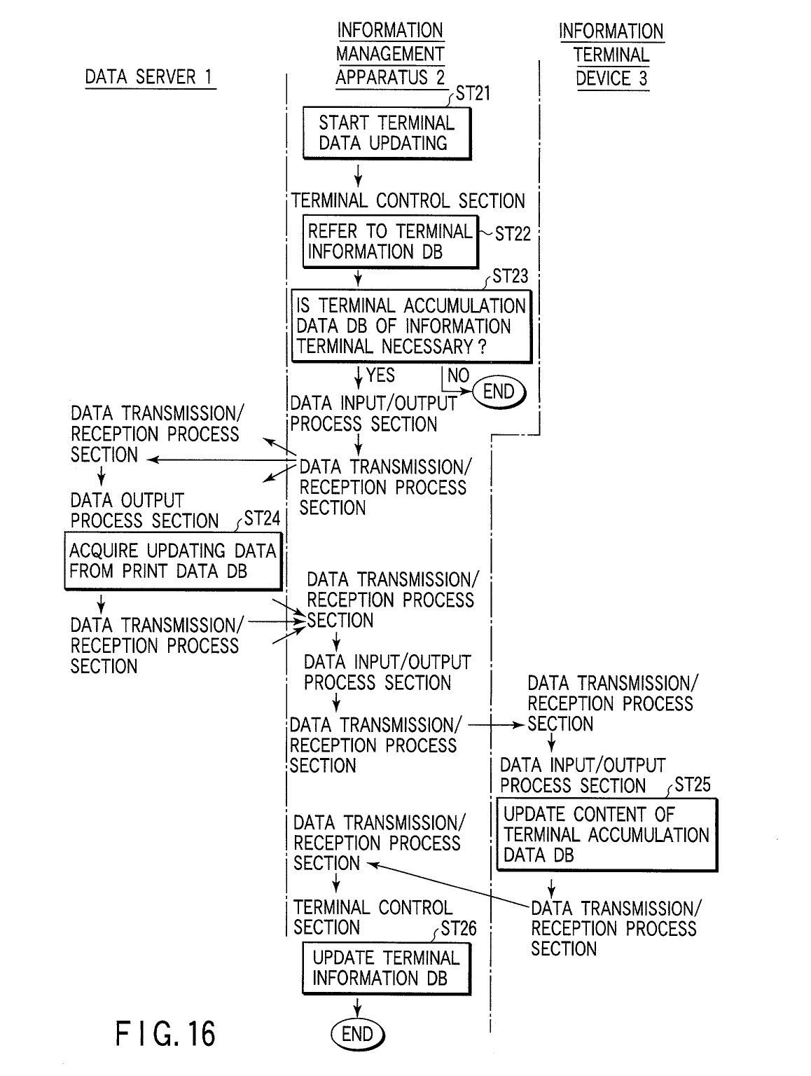

The updating process operation for the terminal accumulation data DB 35 in the information terminal device 3 will now be described with reference to a flow chart of FIG. 16.

When the terminal data updating is started in the information management apparatus 2 (ST21), the terminal control section 21 refers to the terminal information DB 28 (ST22) and determines whether the terminal accumulation data DB 35 in the information terminal device 3 requires updating (ST23). If updating is not required, the process ends.

If the updating is determined to be necessary in step ST23, the data input/output process section 17 transmits updating data transmission instruction information from the data transmission/reception process section 15 to each data server 1 via the network 4.

Based on the updating data transmission instruction information received at the data transmission/reception process section 14, the data output process section 12 of each data server 1 searches the print data DB 9 and retrieves the associated updating data (ST24). Subsequently, the data output process section 12 sends the retrieved updating data from the data transmission/reception process section 14 to the information management apparatus 2 via the network 4.

In the information management apparatus 2, the data input/output process section 17 sends the updating data, which has been received at the data transmission/reception process section 15, to the information terminal device 3 from the data transmission/reception process section 16 via the network 5.

In the information terminal device 3, the data input/output process section 33 updates the content of the terminal accumulation data DB 35 with the updating data received at the data transmission/reception process section 32 (ST25). In addition, the data input/output process section 33 informs the information management apparatus 2 via the data transmission/reception process section 32 and network 5 that the content of the terminal accumulation data DB 35 has been updated (ST25). In the information management apparatus 2, the terminal control section 21 updates the content of the terminal information DB 28 on the basis of the report received at the data transmission/reception process section 32 to the effect that the content of the terminal accumulation data DB 35 has been updated (ST26).

As has been described above, in the case where the information terminal device 3 has the terminal accumulation data DB 35, the content of the terminal accumulation data DB 35 is always kept in the optimal state. Thereby, the traffic with the information management apparatus 2 at the time of print request is reduced, and a quick print process can be carried out. In the information management apparatus 2, the terminal control section 21 manages and controls each connected information terminal device 3 and thus updates the terminal accumulation data DB 35. Since the information management apparatus 2 batch-processes the information of plural data servers 1, the contents of the plural data servers 1 can be simultaneously reflected on the terminal accumulation data DB 35 of the information terminal device 3.

The example of the data structure in the terminal information DB 28 on the information management apparatus 2 is shown in FIG. 10. It is understood, for example, that if a data updating request “Update terminal accumulation data to ‘2000 SUMMER/AUTUMN VERSION’” has been issued, the terminal accumulation data with terminal IDs “01” and “02” requires updating in FIG. 10 and the terminal accumulation data with terminal ID “03” requires no updating (already updated).

If an accounting process or a security management process for limiting processible customers is to be carried out in association with the retrieval process and the print process, the verification control section 22 and accounting control section 23 monitor the input/output data at the data input/output process section 17 and refer to the security DB 29 and accounting DB 30, respectively. Thereby, the accounting process and security process can be batch-managed by the information management apparatus 2.

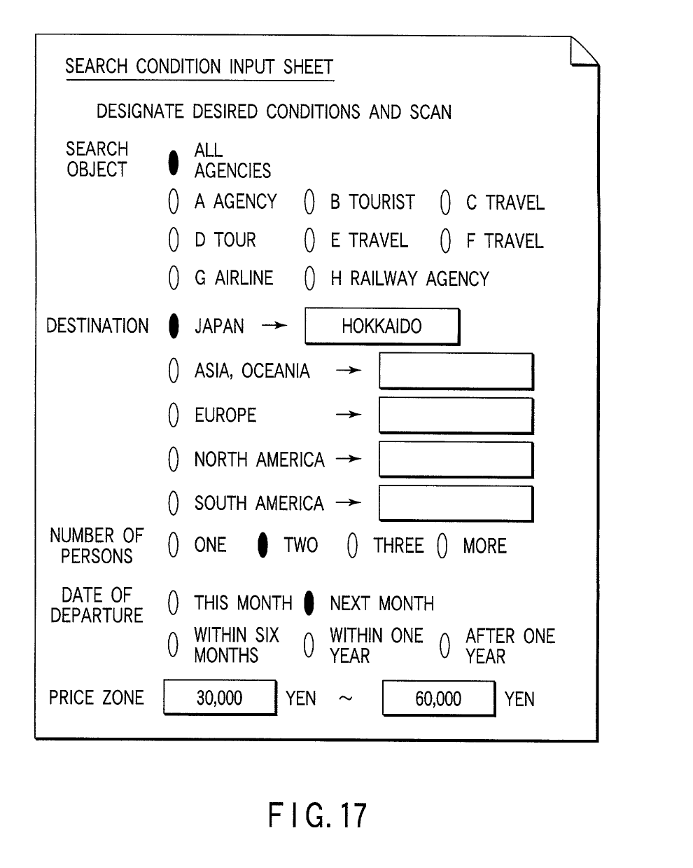

FIG. 17 shows an example of a search condition designation sheet in the case of inputting tour pamphlet search conditions by writing, without using the input/output section (mouse, keyboard, etc.) of the information terminal device 3. Information on the search condition designation sheet shown in FIG. 17 may be scanned by the scan device 40 as input means from the information terminal device 3. With this input method, easy operation means can be provided to customers who are not familiar with operations.

The search condition input sheet may be provided on the information terminal device 3 or may be printed out from the print device of the information terminal device 3 upon the customer's request. The information written on the search condition input sheet is converted to electronic data by mark code analysis, bar-code analysis, handwritten character recognition method, etc. The electronic data is then processed as in ordinary processes.

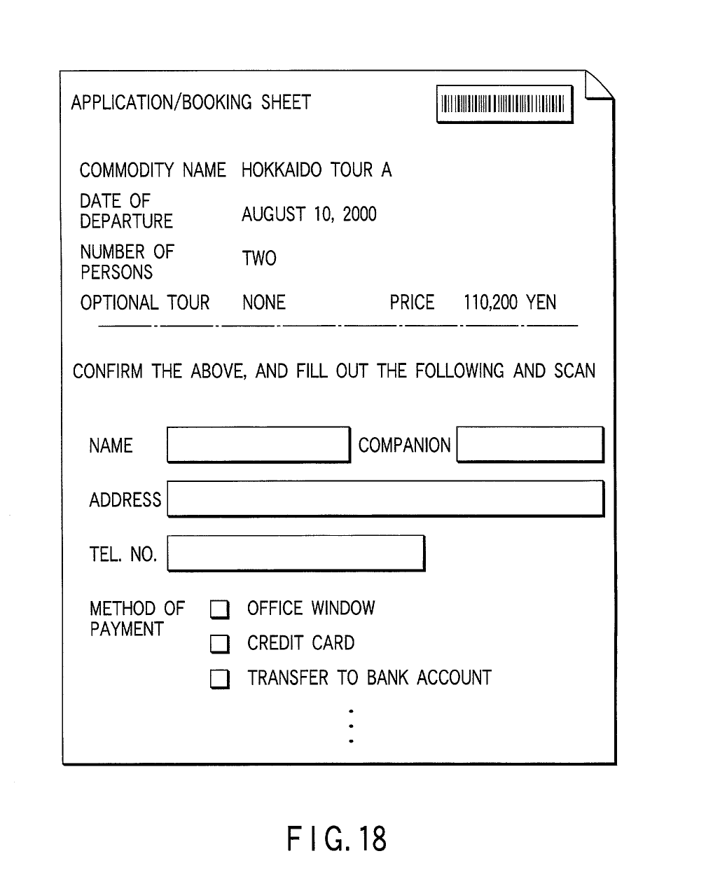

FIG. 18 shows an example of an application sheet in the case of inputting the content of application for tours by writing on paper, without using the input/output section (mouse, keyboard, etc.) of the information terminal device 3. Information on the application/booking sheet shown in FIG. 18 may be scanned by the scan device 40 as input means from the information terminal device 3. With this application sheet, like the search condition input sheet shown in FIG. 17, easy input means can be provided to customers who are not familiar with operations of the information terminal device 3.

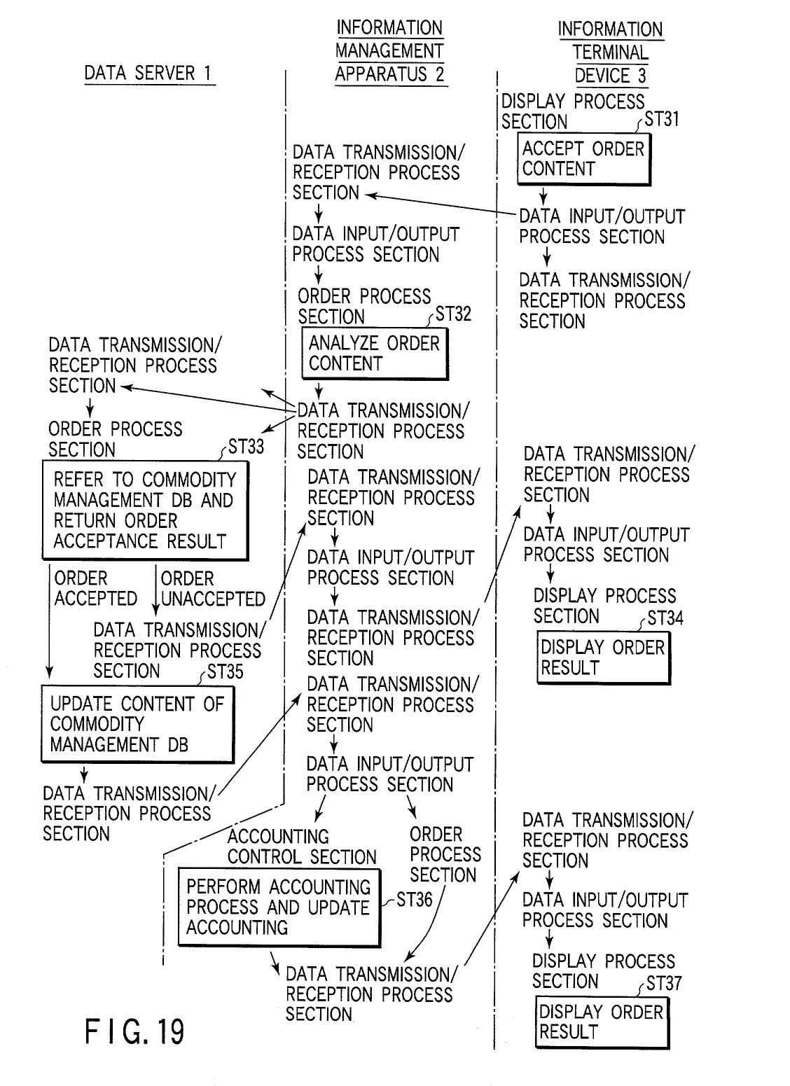

The order process operation for application for a tour, booking a tour, etc. in the information providing system of this invention will now be described with reference to a flow chart of FIG. 19.

If an order is input from the input/output section 42 in the information terminal device 3, the display process section 36 accepts the order content (ST31). The data input/output process section 33 transmits the order content information accepted in the display process section 36 to the information management apparatus 2 via the data transmission/reception process section 32 and network 5.

In the information management apparatus 2, the data input/output process section 17 sends the order content information received at the data transmission/reception process section 16 to the order process section 20. The order process section 20 analyzes the order content based on the received order content information (ST32) and sends the analysis result to the data server 1 via the data transmission/reception process section 15 and network 4.

Based on the analysis result of the order content received at the data transmission/reception process section 14, the order process section 13 of the data server 1 refers to the commodity management DB 11 and returns an order acceptance result to the information management apparatus 2 (ST33).

If the order is unacceptable in step ST33, the order process section 13 sends order unacceptance information to the information management apparatus 2 via the data transmission/reception process section 14 and network 4.

The data input/output process section 17 of the information management apparatus 2 transmits the order unacceptance information received at the data transmission/reception process section 15 to the information terminal device 3 via the data transmission/reception process section 16 and network 5.

The data input/output process section 33 of the information terminal apparatus 3 sends the order unacceptance information received at the data transmission/reception process section 32 to the display process section 36. The display process section 36 displays the order unacceptance result on the display 38 on the basis of the received order unacceptance information (ST34).

If the order is acceptable in step ST33, the order process section 13 of the data server 1 updates the content of the commodity management DB 11 (ST35) and sends the order acceptance information to the information management apparatus 2 via the data transmission/reception process section 14 and network 4.

In the data input/output process section 17 of the information management apparatus 2, the order process is carried out by the order process section 20 on the basis of the order acceptance information received at the data transmission/reception process section 15, and the accounting process is carried out by the accounting control section 23 to update the accounting DB 30 (ST36). Then, the order acceptance information is sent to the information terminal device 3 via the data transmission/reception process section 16 and network 5.

The data input/output process section 33 of the information terminal device 3 sends the order acceptance information received at the data transmission/reception process section 32 to the display process section 36. Based on the received order acceptance information, the display process section 36 enables the display 38 to display the order result to the effect that the order has been accepted (ST37).

As has been described above, the order content is sent from the information terminal device 3 to the order process section 13 of the data server 1 via the order process section 19 of the information management apparatus 2. The order process section 13 in the data server 1 compares the order content and the content of the commodity management DB 11 and determines whether the order is acceptable or not.

If the order is not acceptable, the result is sent to the information terminal device 3 via the information management apparatus 2 and is displayed. If the order is acceptable, the content of the commodity management DB 11 is updated and the order acceptance result (information) is sent to the information management apparatus 2.

The information management apparatus 2 performs the process in the order process section 20 or the accounting process in the accounting control section 23 on an as-needed basis and sends the result (information) to the information terminal device 3.

For example, in the commodity management DB 11 of the data server 1 as shown in FIG. 7, the tour commodity in question is retrieved from the order content, and it is confirmed whether the number of applications has reached a maximum, whether the due date has expired, etc. Thus, the acceptability of the order is determined. If the order is determined to be acceptable, the updating process for, e.g. increasing the number of applications accordingly, is performed.

The above-described specific processes are classified into the retrieval process (the process for retrieving pamphlets), the output process (the process for designating and printing out the desired pamphlet) and the order process (the process for applying for the desired tour commodity). Each process is carried out via the data input/output process section 17 of the information management apparatus 2. The history control section 24 of the information management apparatus 2 monitors the data transactions in the data input/output process section 17 and stores them in the history DB 31 as history information.

In the conventional distribution of paper pamphlets, the state of pamphlet distribution cannot exactly and specifically be understood. However, since the history control section 24 of the information management apparatus 2 employs the history DB 11 as shown in FIG. 11, the date/time of distribution and the details of distribution can be understood. Thus, the potential demand can be understood.

For example, in the case of the application procedures of tour commodity contacts, there is a possibility that all application processes cannot completely be automated, and face-to-face procedures with office staff may be required for part of the procedures. In such a case, the information terminal device 3 of the information providing system of the present invention may be installed in conventional offices, or the information terminal device 3 alone may be installed in unmanned offices. In the case where the information terminal 3 is installed in the unmanned office, a service is required for surely guiding a customer from the unmanned office to an office with staff. In one of methods of this service, the information terminal device 3 of the information providing system of the present invention outputs a map and guidance information for guidance from the current location to the office with staff.

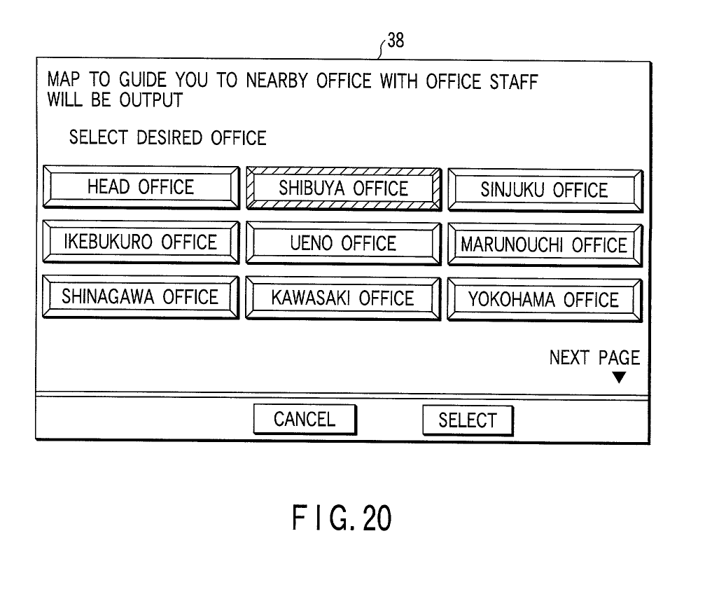

FIG. 20 shows an example of an office designation screen to be displayed on the display 38 when guidance to the office with staff becomes necessary. In this example, some office candidates are displayed, and an office desired by the customer can be selected. The information of the offices listed and displayed on the information terminal device 3 is acquired from the office information DB 27 of the information management apparatus 2. For example, when a need for guidance to an office with staff arises in the unmanned office “SHIBUYA CENTER STREET OFFICE”, the information terminal device 3 of the unmanned office uses the office information DB 27 shown in FIG. 9 and displays the office list as shown in FIG. 20 on the display 38. Alternatively, the information terminal device 3 of the unmanned office may detect the nearby office with staff “SHIBUYA OFFICE” on the basis of the information “NEARBY TERMINAL DEVICE” in the office information DB 27 shown in FIG. 9 and automatically output a guidance map to the SHIBUYA office.

As has been described above, according to the embodiment of the present invention, the information providing system can be managed in a centralized manner using the information management apparatus.

By means of writing on paper and scanning, the search conditions and the application content can be easily input.

By the input/output process history management, the state of information provision can be understood in detail.

The customers can be exactly guided by outputting maps near offices and guidance maps to nearby offices.

What is claimed is:

1. An information providing system having one or more data servers in which various information is registered, an information management apparatus, connected to the data server via a communication line, for managing information, and an information terminal device, connected to the information management apparatus via a communication line, for retrieving and processing information,
wherein the information terminal device comprises:
input means for inputting an information search condition;
first transmission means for transmitting search condition information input by the input means to the information management apparatus; and
output means for outputting one or more information items which are provided from the information management apparatus in response to the search condition transmitted by the first transmission means, and
the information management apparatus comprises:
analysis means for analyzing the search condition provided from the information terminal device;
acquisition means for retrieving and acquiring one or more information items registered in the associated one or more data servers on the basis of an analysis result of the analysis means; and
second transmission means for batch-transmitting to the information terminal device said one or more information items acquired by the acquisition means from the one or more data servers.

2. An information providing system according to claim 1, wherein said input means is a liquid crystal display having a touch panel.

3. An information providing system according to claim 1, wherein said input means includes reading means for reading image information on a sheet on which the search condition is written, and extraction means for extracting the search condition information from the image information read by the reading means.

4. An information providing system according to claim 1, wherein said output means is a display for displaying information.

5. An information providing system according to claim 1, wherein said output means is a print device for printing out information on a sheet.

6. An information providing system having one or more data servers in which various information is registered, an information management apparatus, connected to the data server via a communication line, for managing information, and an information terminal device, connected to the information management apparatus via a communication line, for retrieving and processing information,
wherein the information terminal device comprises:
accumulation means for accumulating various information; and
updating means for updating the various information accumulated in the accumulation means with one or more updating information items transmitted from the information management apparatus, and
the information management apparatus comprises:
determination means for determining whether the various information accumulated in the accumulation means should be updated or not;
acquisition means for acquiring, when the determination means has determined that the various information should be updated, one or more updating information items registered in the associated one or more data servers; and
transmission means for batch-transmitting to the updating means the one or more updating information items acquired by the acquisition means from the one or more data servers.

7. An information providing system according to claim 6, wherein said acquisition means includes updating information accumulation means for accumulating in advance one or more updating information items registered in the one or more data servers.

8. An information providing system having one or more data servers in which various information is registered, an information management apparatus, connected to the data server via a communication line, for managing information, and an information terminal device, connected to the information management apparatus via a communication line, for retrieving and processing information,
wherein the information terminal device comprises:
display means for displaying various information;
input means for inputting an order associated with the information displayed on the display means;
first transmission means for transmitting order information input by the input means to the information management apparatus; and
display means for displaying order result information provided from the information management apparatus in response to the order information transmitted by the first transmission means, and
the information management apparatus comprises:
analysis means for analyzing the order information provided from the information terminal device;
process means for carrying out an order process to the associated data server on the basis of an analysis result of the analysis means; and
second transmission means for transmitting order result information processed by the process means to the information terminal device.

9. An information providing system according to claim 8, wherein said process means includes accounting process means for performing an accounting process associated with the order.

10. An information providing system according to claim 8, wherein said input means includes reading means for reading image information on a sheet on which the order information is written, and extraction means for extracting the order information from the image information read by the reading means.

11. An information providing system having one or more data servers in which various information is registered, an information management apparatus, connected to the data server via a communication line, for managing information, and an information terminal device, connected to the information management apparatus via a communication line, for retrieving and processing information,
wherein the information terminal device comprises:
input means for inputting information process request data;
first transmission means for transmitting the process request data input by the input means to the information management apparatus; and
display means for displaying information which is provided from the information management apparatus in response to the process request data transmitted by the first transmission means, and
the information management apparatus comprises:
analysis means for analyzing the process request data provided from the information terminal device;
acquisition means for retrieving and acquiring one or more information items registered in the associated one or more data servers on the basis of an analysis result of the analysis means;
second transmission means for batch-transmitting to the information terminal device said one or more information items acquired by the acquisition means from the one or more data servers; and
history management means for managing history information relating to the process request data provided from the information terminal device.

12. An information providing system according to claim 11, wherein the process request data input by the input means relates to a retrieval process, a printing process or an order process.

13. An information providing system having one or more data servers in which various information is registered, an information management apparatus, connected to the data server via a communication line, for managing information, and an information terminal device, connected to the information management apparatus via a communication line, for retrieving and processing information,
wherein the information terminal device comprises:
display means for displaying, where necessary, guidance information including a map for guidance to a nearby office with staff, in a case where the information terminal device is installed in an unmanned office;
instruction means for instructing printing of the guidance information displayed on the display means; and
printing means for printing the guidance information according to the instruction by the instruction means.
